(19) United States
(12) Patent Application Publication
(10) Pub. No.: US 2016/0353519 A1
(43) Pub. Date: Dec. 1, 2016

(54) System and Methods for Power Distribution to Mobile Devices at Points of Interaction

(71) Applicant: Mark Francis Kogen, Torrance, CA (US)

(72) Inventor: Mark Francis Kogen, Torrance, CA (US)

(21) Appl. No.: 14/722,884

(22) Filed: May 27, 2015

(51) Int. Cl. H04W 88/02; H02J 7/02; H02J 7/00

(52) U.S. Cl. CPC H04W 88/02; H02J 7/0052; H02J 7/025

(57) ABSTRACT

This system and methods provides for a power source to drive a mobile device at a point-of-interaction either as an integrated or stand beside component of a point-of-presence device to enable the mobile device to be used as part of a transaction/interaction. In this context a transaction is an interaction between a mobile device and another electronic device or individual in which the mobile device conveys information identifying the holder of the device as being specifically qualified to receive goods or services based upon delivering said information through the mobile device and any verification and/or approvals that may be required by the receiving entity. The context of this is twofold, supporting both the identification and verification of the service recipient as well as the delivery of the specific credentials which, by verification and authorization of the credential, enable the interaction to conclude. The power shall be made available in the event that the power source for the mobile device is drained or non-functioning. Further to the invention is the possibility that the system may include controls which limit the power source availability such that the power source shall not provide recharging service.

### FIELD OF INVENTION

The present invention relates generally to the fields of computer technology, power distribution technology supply and regulation, transaction point-of presence devices in retail and other commercial and consumption activities, networks, communication technology.

### BACKGROUND OF THE INVENTION

The mobile landscape is exploding. Not just phones but tablets and other devices are creating an environment where individuals can access an ever growing set of services digitally via numerous channels available through these devices. As the utilization of mobile devices grow and the intelligence and communications available within these devices grows these factors provide even greater opportunity for individuals to take advantage of services available through those mobile devices. With this growth in capability, the ability to reliably transact with the device becomes critical to the successful delivery of those services. In many instances the mobile device replaces a different mechanism that is used to identify the bearer as authorized to perform a specific type of interaction that enables that individual to gain access to or acquirer a particular commodity or service.

The context of this is twofold, supporting both the identification and verification of the service recipient as well as the delivery of the specific credentials which, by verification and authorization of the credential, enable the interaction to conclude. Consumers shall have credentials stored within their mobile device and available through remote stores either previously obtained or obtained in a near real-time manner. Identification and verification of said consumer as qualified to obtain or receive delivery of prequalified credential for said service, may be handled locally if appropriate application qualified entry and validation mechanisms are integrated with the mobile device. Equally acceptable is utilization of a remote interaction model which based upon the value and risk of the credential acquisition, a variety of methods may be employed by the service provider to ensure that an appropriate strength of verification is applied. These actions require power to be available within the mobile device to activate and process the underlying service as well as, in the case of a remote interaction; one example being a cloud based implementation; employing communications with a remote entity, power additionally being available to drive said communications.

The second aspect of the interaction is the delivery of the information to the accepting device, in this context an interaction is an information exchange between a mobile device and another electronic device or individual in which the mobile device conveys information identifying the holder of the device as being specifically qualified to receive goods or services based upon delivering said information through the mobile device and any verification and/or approvals that may be required by the receiving entity. Again power is required within the mobile device to exchange that information.

Examples of such interactions include but are not limited to:
Payment for the acquisitions of goods or services utilizing a mobile “payment card” which is accepted by the provider as a promise to compensate them for said items.
Displaying/delivering a digital representation of a ticket for a Movie, Theater, Sporting event, . . .
Displaying/delivering a digital representation of a reservation for a hotel, restaurant, transit passage (e.g. airline, train, bus, . . . ) . . .
Displaying/delivering a digital representation of a pass for transit, theatrical or sporting season events, . . .
Delivering a digital key to unlock a hotel room, access an office or lab, open a car door, . . .

In all of these cases at the point of transaction/interaction; for theater it could be at the entry door, at a store it could be the register counter; a presentation of the appropriate credential is required complete the transaction. If a mobile device is used to deliver that credential then a lack of power available in the device will not allow the transaction to complete, impacting the mobile device holder and the service provider.

Mobile devices being portable they typically derive the energy for their operation from a portable power source i.e. battery. During normal use there exists the possibility that a battery could be drained rendering the device temporarily inoperable. At that time an individual will not be able to complete acquisition of a specific service given this lack of power available to operate the mobile device. This system and methods addresses this deficiency by providing the mobile device with a locally available power source at the point-of-presence where the interchange occurs enabling the individual to qualify for the acquisition of the desired product or service.

Typically power can be supplied to a device via one of three approaches
1. Insert a replacement battery that holds a charge adequate to power up and perform the necessary transaction.
2. Connect the device to a power source via a cable from a power source to the mobile device connector that is normally use to plug in the device to a power adapter when the device is subjected to its normal recharging process.
3. Utilize induction to create an electromagnetic field which can deliver power as well as transmission intelligence (depending upon system protocols) between subsystem components.

Battery replacement is not practical from either an economic or logistics perspective. There are too many different form factors for these batteries and to have a supply of all possible packages at every point of presence would be unwieldy. Additionally, the different physical form factors and power profiles require a variety of different adapters to keep the batteries charged. Furthermore, certain form factors, some tablets as an example, have sealed enclosures requiring professional service personnel to disassemble and replace. For all of these reasons option one is not feasible.

However the other two options are at the core of this invention. As the mobile device sector has matured there has been more and more standardization of the interface connectors. At this time the mini USB style predominates. That of course is outside of the Apple product line which utilizes their proprietary pin out and connector design. Additionally devices come with multiple RF communications protocols built into the devices some of which support power delivery through electromagnetic induction. Another form of power charging available today utilizes induction pads which introduces a plug-in housing which is connected to the mobile device's charging port and when the device is placed upon an induction mat; power is transmitted through the adapter to recharge the mobile device.

This invention utilizes these technologies and applies them to provide both integrated and stand beside solutions enabling a mobile device to deliver the appropriate credentials even if the situation involves the case that the mobile device has inadequate available internal power.

### BRIEF SUMMARY OF THE INVENTION

The present invention discloses systems and methods utilizing electronic circuitry, power delivery, computer programs and communications channels for the purpose of providing temporary power to enable an individual with a mobile device to utilize the device to provide appropriate identity, credentials, tokens, tickets or reservation data enabling them to complete a transaction and/or authenticate their rights to receive or access specific items, locations and/or services when the internal power source of the mobile device is deficient.

### BRIEF DESCRIPTION OF DRAWINGS

FIG. 1 is a conceptual schematic representation of one embodiment of the invention based upon an alternating current power source and connected distribution.

FIG. 2 is a conceptual schematic representation of one embodiment of the invention based upon a direct current power source and connected distribution.

FIG. 3 is a conceptual schematic representation of one embodiment of the invention based upon an alternating current power source and inductive distribution.

FIG. 4 is a conceptual schematic representation of one embodiment of the invention based upon a direct current power source and inductive distribution.

FIG. 5 is a conceptual schematic representation of one embodiment of the invention based upon an alternating current power source delivering either connected or inductive distribution.

FIG. 6 is a conceptual schematic representation of one embodiment of the inductive adapter for a mobile device which is a component of this invention.

### DETAILED DESCRIPTION OF THE INVENTION

Starting with the proliferation of “smart” phones and the widespread use of tablets, in many cases the later replacing traditional PCs for personal use, many commercial and industrial sectors are taking advantage of both the computing power and portability of these platforms. It is common to see the mobile device being used as both a conduit and repository for credentials that are used to identify the holder as qualified for some product or service. The range of credential use is very broad. It can be as simple as a generic coupon which indicates that any holder of the offer obtains some kind of discount on the commodity associated with the offer. It can be a directed offer tailored for an individual or specific group and only those individuals qualified can make use of the offer. It can represent a prior purchase qualifying the holder access to specific services or goods. Theater tickets, ticket to sporting events, concerts, season passes with many related services, . . . are examples of these types of products. These could also be airline tickets, hotel reservations, dinner reservations or facilities access. It can also be payment credentials which are used at points of presence to indicate that the holder agrees to pay the merchant for the goods or services being exchanged and that the holder is authorizing the institution that granted the credential the authority to move those funds from the account associated with the credential to the account of the merchant.

The data representing these credentials may be stored locally on the mobile device or in remote servers, however the mobile device is used at the point-of-presence to identify the holder and initiate or deliver the credentials to recipient. In today's vernacular a cloud service is one example of a representation of said remote server environment. Storing credentials on a Secure Element resident within the mobile device is an example of locally stored credentials. This type of data store is required for only the most sensitive of credentials.

At point-of-presence the credential could be displayed and/or delivered via a data communications channel to a merchant device to convey the credential information. A visual display is either presented to merchant representative who can either:
key in the information for verification or
can scan and confirm the information; for example that the information is presented as a barcode form.

If the exchange utilizes a data channel from the mobile device then the device must have the appropriate applications and active communications protocols engaged to interact with an intelligent device at the point-of-presence, to complete the exchange.

In all of the instances if the mobile device does not have power than the exchange cannot occur. Thus inhibiting the ability of the mobile device owner from receiving the goods or services desired and creating a situation in which the commerce associated with the interaction cannot be completed or a horrible experience in that products previously purchased, e.g. theater tickets cannot be used even though the consumer has properly purchased a right of entry.

At the core of this system and methods are solutions that provide power at points-of-presence, for a vast majority of mobile devices, enabling them to complete these transactions. Furthermore this system has the ability to protect the holder of the charging environment from abuse. These methods provide power to enable a device to complete a transaction ensuring successful commerce and service delivery; however it is not the intent of this solution to create a recharging station capable of filling the devices battery storage. In certain environments replenishment of the devices battery power stores would entail a significant additional expense for the merchant and therefore one option enumerated in the methods of the present invention is the ability to restrict said feature, limiting power delivery to a reasonable timeframe to complete a transaction.

To frame the discussion this description shall focus on Point of Sale, POS systems. The system and methods described here can be implemented in any other electronic device utilized to capture and qualify the rights associated with a credential as described above. An engineer knowledgeable in the art shall be able to create the same power delivery and control mechanisms for form factors in addition to the POS system described here. The set of devices may include but are not limited to:
Retail point-of-sale terminals and registers
Door poppers (locks)
Ticket scanning devices
Boarding scanners
Retail and Service kiosks, . . .

With the advent of payment credentials hosted on portable devices there is a need to ensure that a consumer can complete their transaction even if their portable device is short on power. The battery in the device could be low or depleted of charge adequate to power the device. This invention introduces a power delivery mechanism within the POS system by which a wide range of portable devices shall be supported and by which the POS system shall deliver the power necessary to activate the device and complete the transaction. This is not intended to be a recharge station, but as a temporary power source utilized by a merchant to enable powering a device holding a payment credential or access to a payment credential.

This system supports two approaches by which power can be delivered to a mobile device.

1. Physical connection

2. Induction
1. In the early days of mobile devices there was a wide variety of connector configurations across manufacturers and often within a single manufactures' product line. This was due to differences in device capabilities, the rush to deliver product and the attempt to create additional sales of aftermarket products by requiring new components to be purchased every time a new device was acquired. However standardization has occurred and today there are primarily two connector types used for most mobile devices. Mini USB (Universal Serial Bus) and Apple are the two standards. In the future this may change. However with the creative design described herein the ability to deliver power to a range of devices can be achieved at a relatively low price point. In this scenario the mobile device shall be plugged into a power source enabling the device to be activated, the appropriate applications initiated and the transaction to be completed.
2. The use of antennas and/or a coil creates the opportunity to generate an electromagnetic field which can be used to transmit power to a device. This is feasible as long as the device has a similar antenna or coil to receive the power. This is applying the principles of induction. Today there are in home power pads that utilize induction to allow a device to be recharged. Typically a device utilizing this mechanism has a special sleeve or a small module that is plugged into the device's power adapter connector. The power pad is plugged in and when a device with the appropriate attachment is placed on the pad it is exposed to the Electromagnetic Radiation, EMR of the pad. Through induction the EMR is captured by the adapter and converted back to an electronic charge which is passed through the device connector and stored in the device's battery. Another method by which induction can be utilized to power a device is through the use of RF based induction communications. NFC, Near Field Communications is one such standard. Today many mobile devices are being deployed with integrated NFC capability. NFC is based upon the International Organization for Standardization, ISO, standard 14443 which is used for a wide range of touch and go services ranging from facilities access, transit and mobile payment at POS. This technology has the ability to deliver power as well as transact and as such provides another opportunity to introduce power delivery through induction.

The system and methods described here utilize these two technologies, wired and inductive power distribution to provide the temporary power source needed to deliver the power necessary to activate a mobile device and the required programs to manage that power distribution.

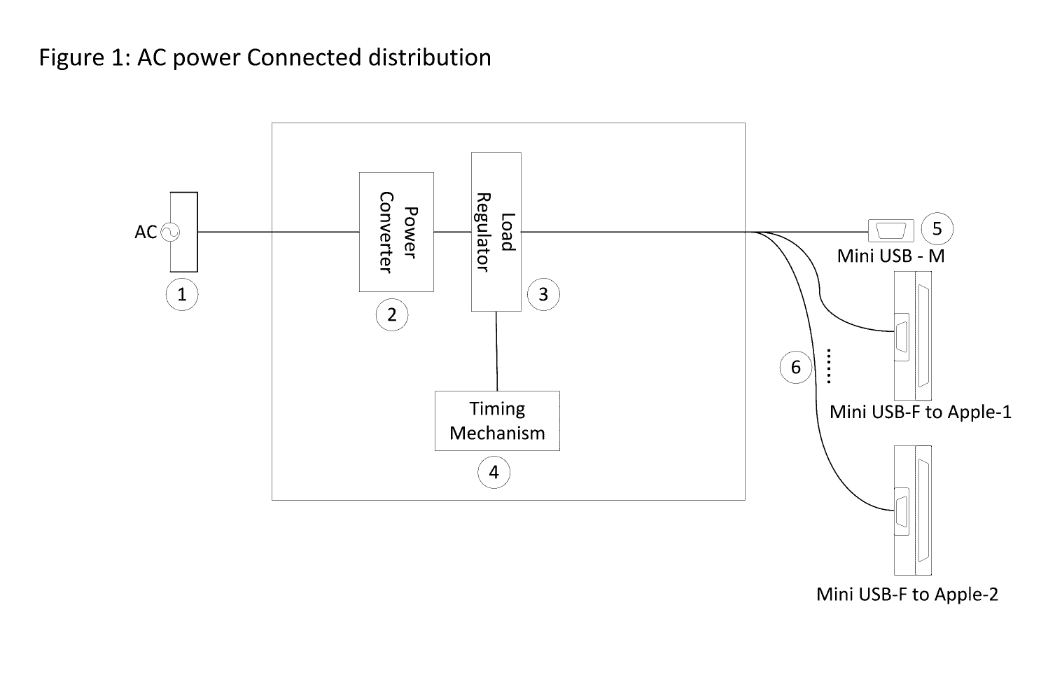

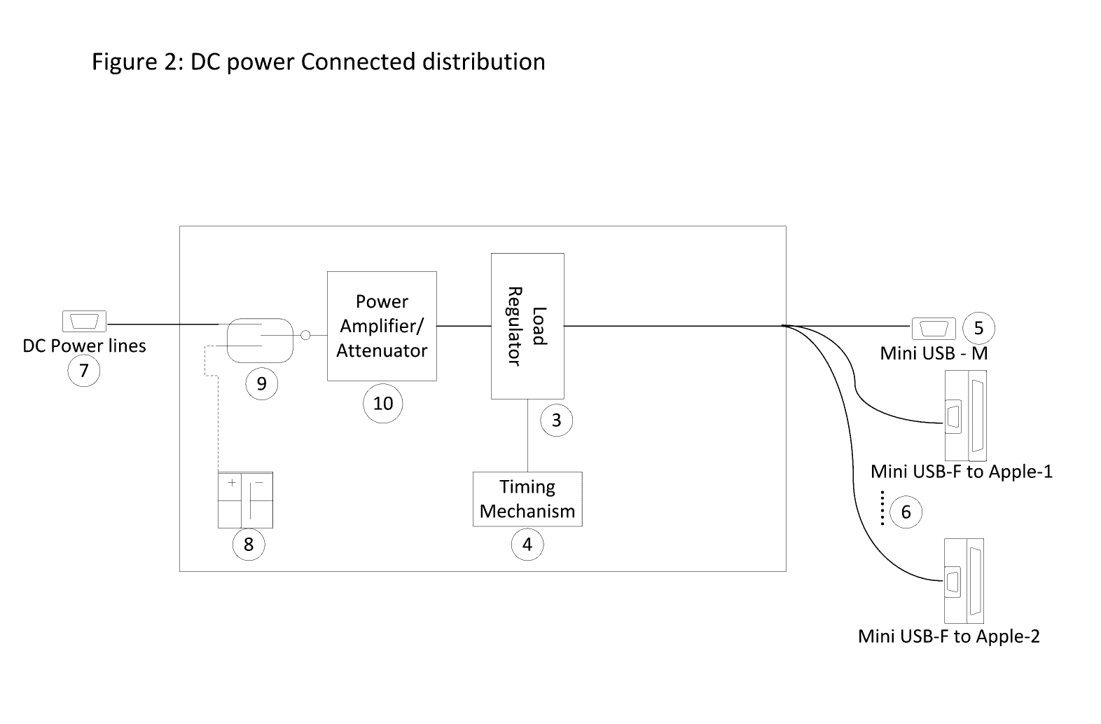

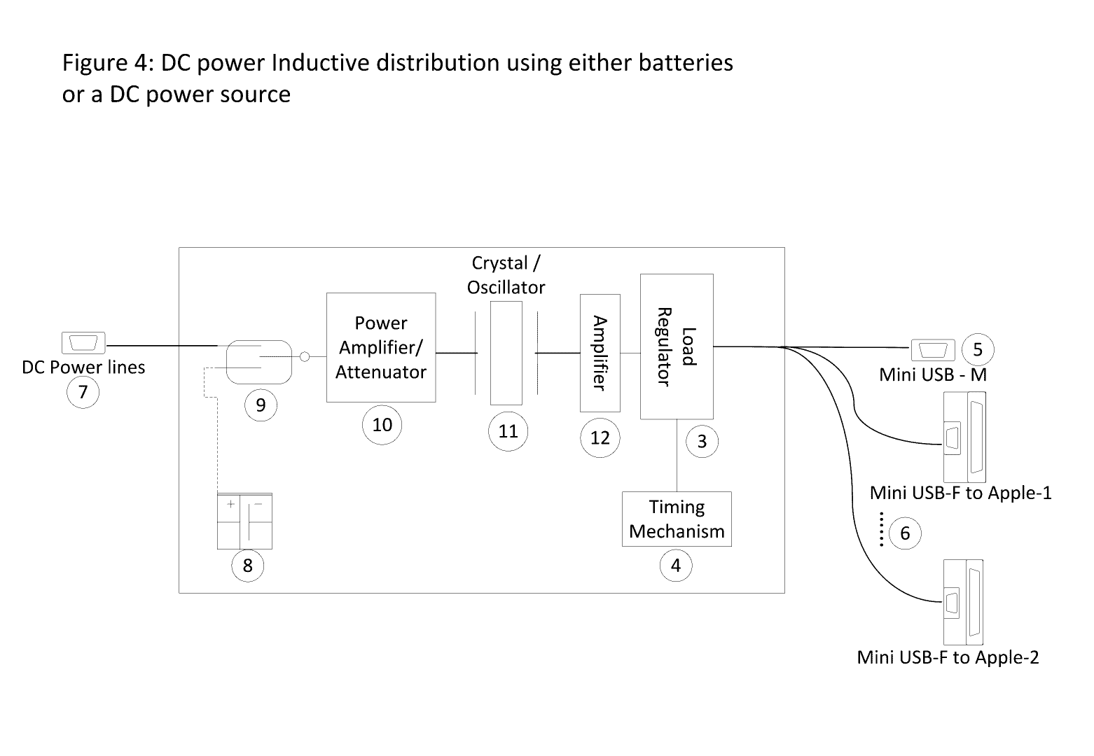

The solution requires a power source. This power source shall be either wired AC power through a connection to a facility's physical plant through a point-of presence accepting device or through a stand-beside unit configured to provide this temporary power source or from power derived from another mobile device, e.g. a battery in a handheld POS terminal provided tableside in a restaurant. FIGS. 1, 3 and 5 depict conceptual schematics for various solution methods utilizing AC power 1 as the source. FIGS. 2 and 4 depict conceptual schematics for various solution methods utilizing direct DC power 7 or DC power supplied via a Battery 8 and a Selector Mechanism 9 which would be in place if both alternative sources were to be offered. The Selector Mechanism 9 is attributed in these drawings to represent the possibility that a DC source could be either:
1. Distributed from the internal power of the source device
2. Distributed from a battery within the source device
3. Available from either an internal power distribution or battery source selectable by a control system within the device.

FIGS. 1 and 2 depict the constructs employed for delivery of physically connected methods. As required the AC power source shall pass through a power converter 2 as mobile devices typically require DC input for charging. The power converter 2 shall function to convert AC to DC when required by the mobile device. With a DC power source one needs to ensure that the power supplied to the load regulator 3 is sufficient to support device loading requirements. As such a Power Amplifier/Attenuator 10 is described in the schematics to ensure that adequate source energy is available to the Load Regulator 3. For both AC and DC power source solutions the Load Regulator 3 shall enable circuitry to determine the mobile device power requirements and present an appropriate charge level for said device.

In the event that the implementation is a connected implementation; physical connection with wires, the power leads shall be exposed from the source device. The wires shall be terminated in an appropriate base connector. Based upon the state of the art in the industry today this connector could be of a male Mini-USB form factor 5. Only those connector pins associated with power delivery need be enabled. To support the possibility that not all mobile devices accept this primary connector interface a select set of Alternate Connectors 6 shall be provided. Following the example described above, these pass-through adapters shall on one side utilize a female mini-USB connector and on the other have the appropriate connector for the device class being supported. For example Apple has both a 30 pin and an 8 pin connector depending upon the generation of the device class. Two adapters would be required to support all generations of Apple phone devices. In the attached figures the Mini USB—Apple connector adapter 6 configurations are used to represent the broad spectrum of possible alternative adapters and is not expressly limited to the Apple alternatives. The use of the ( . . . ) in the drawings is representative of that abstraction.

Since handling multiple connectors are always challenging and the likelihood of lost connectors high the intent is that the connectors shall be packaged as a composite component. Implementation shall be either:
All connectors shall be package in a single assembly with the extension cable into which the mobile device shall be connected. The fabrication of this special structure creates one component for the cable and set of adapter connectors. One instantiation of this cable is a cable with a terminating male mini-USB connector 5 on one end. Physically attached to the cable housing 6 are tethers with each alternate connector configuration attached. The length of each tether is sufficient for each adaptor connector to be selected and physically inserted onto the cables terminating connector to establish an interface into which the mobile device may be connected. This structure creates the most secure implementation minimizing the possibility that any one supported interface is not available as a connector could be lost if they were all separate adapters. The drawback to this approach is that over time as new devices and device interfaces are introduced into the market it will be more costly to update the power distribution system.
Alternatively the power distribution system may include a cable with for example a mini-usb terminating connector 5. Additional adapters 6 provided as separate components. Each adapter as described above is an independent element the responsibility of the location staff to track and provide to clients when needed. This solution is simpler to produce and makes pricing individual interfaces possible leaving it to the user to determine the range of mobile devices they wish to support. This provides a potentially lower cost entry point with higher operational overhead.
A third alternative is to create the primary cable with just the basic interface and provide additional adapters as separate elements with a feature that allows them to be connected together and attached in some manner to the transacting system. Examples of such approaches include but are not limited to each adaptor having:
   1. A trailing zip tie equivalent strip which can be used to secure each connector to for example the primary distribution cable. This is the methodology represented in the included figures. For example in the connected distribution drawings FIGS. 1 and 2, the cable terminating with the Mini USB—M connector 5 is the cable through which the power is delivered. The other Adapters 6 are a series of pass-through devices, the cables just being attachment ropes. To make use of one of the Adapters 6, for example the Apple-1 adapter one would insert the Mini-USB-M connector into the mini-USB F side of the Apple-1 adapter. The adapter would then be inserted into the connector on an iPhone to obtain power.
   2. The housing of each adapter has an interlocking mechanism such that the adapters can be lock together to create a block of connectors which can then be provided to the mobile device owner to provide the proper connection.

In the event that the system is implemented in an integrated manner, for example as an extension of an existing transaction acceptance, device circuitry shall be included to ensure that a device requiring excessive load cannot adversely impact the primary system. For example in the event that power is attempted to be introduced into the system or if the load would draw so much power through the system as to damage the internal electronics of that device, circuitry shall be in place to prevent such occurrences. In these schematics the Load Regulator 3 would handle that process.

The purpose of this solution is to provide power to a mobile device for a short period of time to enable the device to participate in some form of interaction. The intent is not to create a charging station for mobile devices. To that end an optional method of this system is to include circuitry to limit the power cycle. The basic circuitry shall be implemented to sense when a device connects to the power distribution cable or is placed in the RF induction field. At that point a timer shall be activated that shall, after a defined period of time, terminate power delivery. The packaging of the sensors and the circuit controlling timing is represented by the Timing Mechanism 4 in the included figures. The determination of the cutoff point shall be achievable via three possible mechanisms depending upon the particular form of the power distribution device. The alternatives are:
1. A configuration switch in the device. The switch settings establish different clock timer values. This limits the alternative settings for the power allocation to a fixed set of values based upon the counter values and the clock rate.
2. The solution having a microprocessor can also have a separate program which can control the timing mechanism. This takes an input parameter and the timing mechanism shall be under program control. To configure such a device either the system shall have a display or shall have a digital interface via which the code can be loaded and configured.
3. A special case of option 2 stated above is the case where the power distribution system is integrated as a subsystem of an existing device which includes intelligent processing capability. In that case the solution may be able to leverage existing programming and configuration capabilities or extend those capabilities to create a cutoff timer for the power distribution service.

As this is an optional feature it is also possible to deliver a device that does not include any such limiting capability. In that scenario there would be nothing preventing the power distribution system to be used to recharge the batteries of a mobile device.

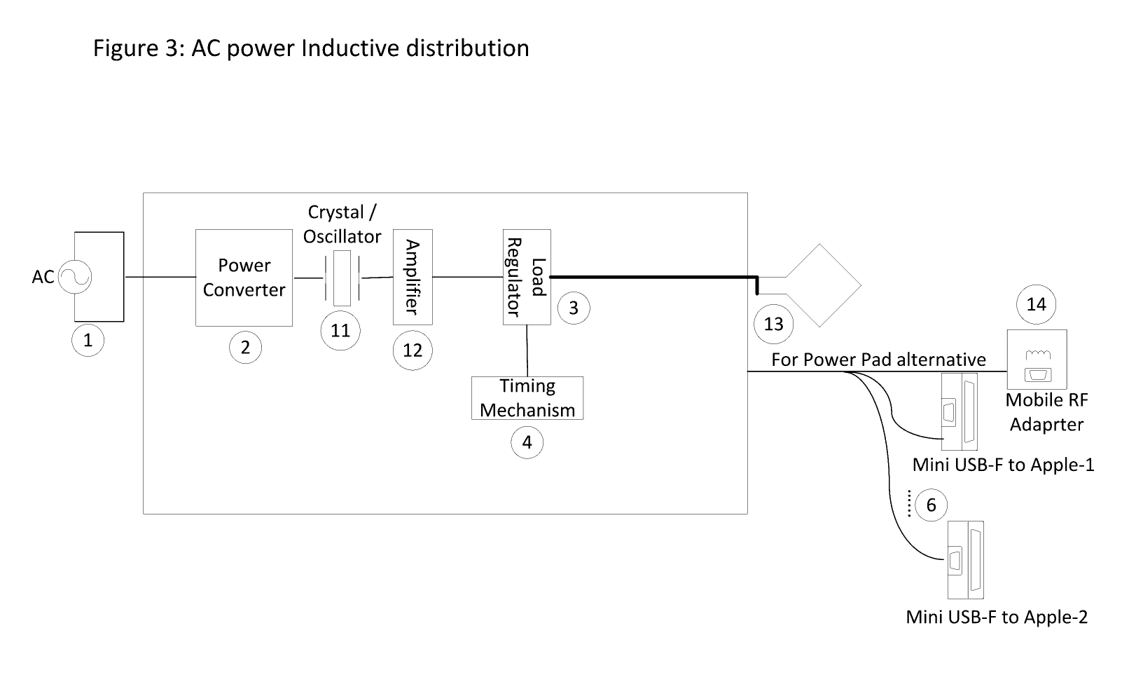

In the event that the solution utilizes induction rather than a hardwired connection, the electrical requirements differ. FIGS. 3 and 4 provide conceptual schematic representations of the induction methods.

The power source alternatives are the same as described above in the connected output alternative.

The power delivery is through a radiation field generated by an Antenna 13. That requires that the power always be applied to the antenna so when a device enters the field the power is available for consumption. Having the power always on, is a straight forward but suboptimal design. This is one implementation option; however an improved alternative would be to incorporate a sensor as part of the Antenna 13 assembly which would identify when a device has entered the field. Upon entry the power level would be increased to provide sufficient radiation to induce appropriate power transmission. For example the sensor could utilize RF, optical or pressure technology to identify the entry of a device into the radiation field of the antenna. The solution does not limit the type of sensor technology. The solution recommends that a sensor be present for optimal performance, however does not require one.

To create the required RF Electromagnetic field oscillating energy is required. Where in the connected solution a DC current output is required, here an alternating current is required. In addition the incremental circuitry shall incorporate an RF modulation module one example of one is a crystal 11 and RF amplifier 12 feeding into a load regulator 3 , which delivers the RF energy to an antenna assembly 13. The crystal is one representation of an energy generating oscillating element. A tuned coil is another. In a tuned coil representation AC current would drive the operation. Further either the sensor within the Load regulator module 3 and the timer circuitry 4 shall be included in the solution that limits power delivery duration. Finally in the event that the induction solution requires sets of connectors for the device a similar approach would be taken to that described above for the wired connections. In that scenario the primary connector would be the Mobile RF Adapter 14 which in this example based upon the state of the industry today would have a USB-M connector for interconnection with the mobile device. The same set of alternate adapters 6 shall be tethered together with the Mobile RF adapter to create the connector set supporting device diversity. This mirror's the design concepts of a power pad utilized as a recharging station and would be required in the event that the mobile device does not have the required NFC or NFC equivalent technology in place to accept the RF power source.

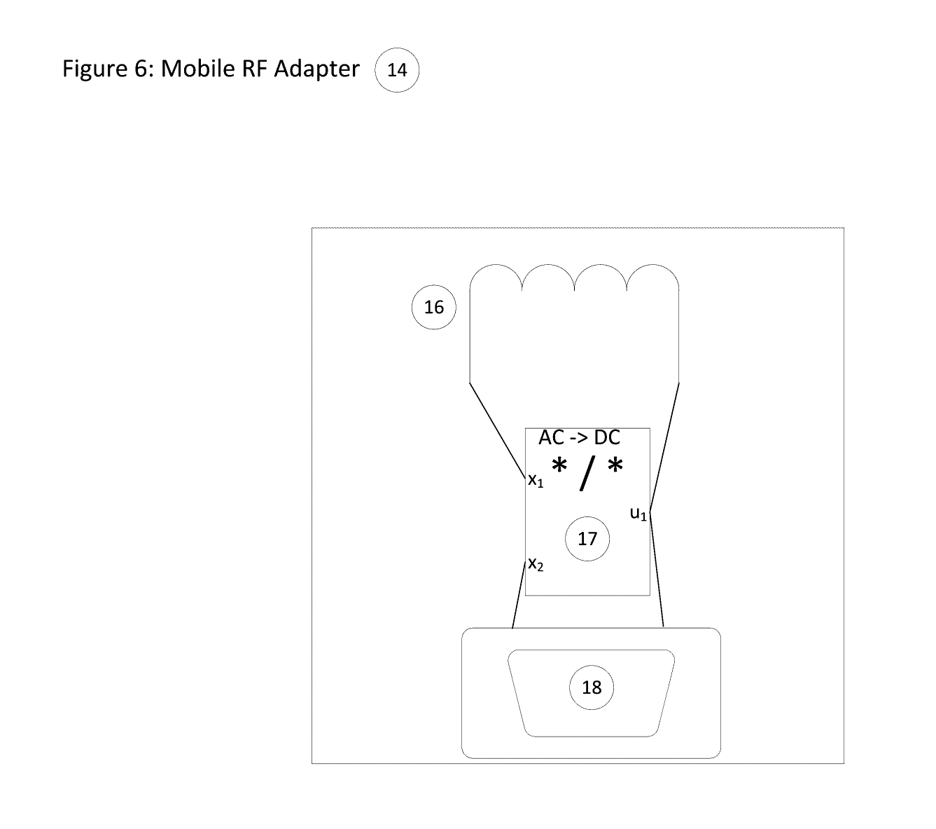

In this instantiation of the solution the RF connector module depicted in FIG. 6: Mobile RF Adapter shall include an antenna assembly 16 and a power conversion and load regulatory assembly 17 and the mini-USB-M 18 connector. These are housed in a single assembly which has an output connector that mate's with either the mobile device connector or one of the included connector adapters 6. Using the examples described above this would include at a minimum but not be limited to, 3 separate assemblies one for mini-USB, and one for each of the Apple standards. In another instantiation of the solution one could create a single mobile device RF connector module, for example supporting the mini-USB configuration. Then using the same adapters described above, in the wired implementation, use those adapters to enable the RF module to be interconnected with mobile devices using current connection standards. This is the instantiation depicted in FIGS. 3, 4, and 5. The packaging options for the RF module for the mobile devices and the alternate connector adapters shall have the same set of options described for the wired mobile adapters.

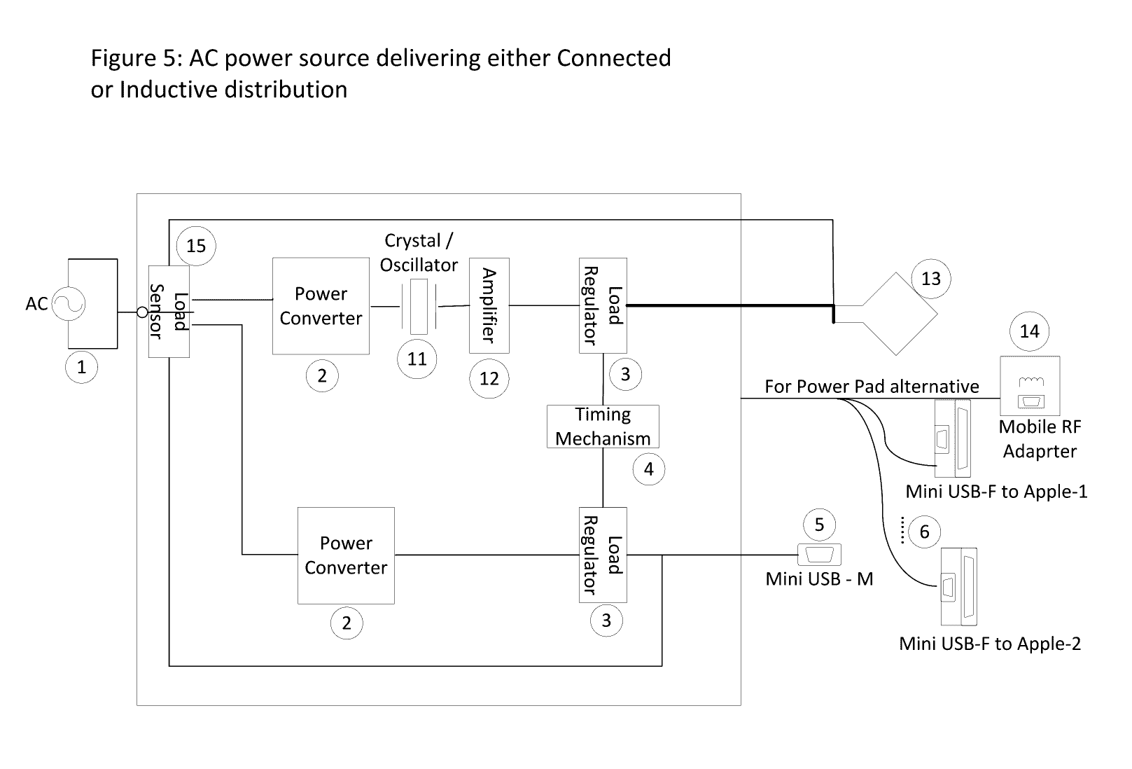

A further alternative in the methods introduces a design which combines the RF and wired solution. A likely scenario would for example an existing retail point of sale device which incorporates NFC technology; with the possible requirement that it need to increase the RF output to provide sufficient energy to create the appropriate charger to power the receiving device. If the customer holds a device that is not NFC capable then they would revert to the wired approach to provide device power and display or deliver the necessary information after device activation. FIG. 5 provides a conceptual schematic representation of this approach. Note that this drawing assumes that an AC power source is utilized. By replacing the AC components up through the Power Converter by the DC components from source up through the Power Amplifier/Attenuator 10 for example from the drawing as depicted in FIG. 2, a combined alternative driven by a DC source is also envisioned. Note that in this instance the Load Sensor 15 would sit between the DC selector 9 and the Power Amplifier/Attenuator 10.

This power distribution assembly whether wired or using induction can be integrated with an existing servicing system or be packaged as a separate module and operate in a stand beside mode. There are three alternatives defined for this integration. For clarity in this discussion a retail POS terminal is being used as an example of an accepting device. The integration alternatives work for any other accepting device, including but not limited to, ticketing, ticket accepting, reservation processing, access, purchasing, . . . , devices.
1. The power distribution assembly can be integrated with an existing platform. Given the capabilities of the device and the availability of existing connectors in one instance power can be drawn through an existing connector. In this scenario a cable is attached to an existing port on the POS device. Attached to that cable is an adapter module with the additional electronics described above depending upon the wired or induction based alternative. For the wired case the module has an additional cable exiting the adapter module which has for example, the min-USB connector as described above and additional set of adapter connectors to support various mobile devices. For the induction case the module either incorporates the antenna directly or has an appropriate RF cable exiting the device to which the antenna touch point platform is connected.
2. In the event that power through an existing connector is not available and a redesign of the accepting device is possible, then the instantiation of the solution is to integrate these services directly into the device. Adaptation of the internal power distribution system is required to provide the power required to drive this subsystem. Power from the internal device distribution system would then be used to drive the subsystems described above. Those components shall be integrated within the accepting device enclosure with the exception of the external cable for the wired connection or the antenna subassembly if design requires that it be separate. In the case of POS devices that support NFC the implementation shall support repurposing that antenna to support power distribution for both NFC and power pad based mobile device environments.
3. In the event that the power profile for an accepting device does not have the capacity to accommodate the additional load require to deliver this service, then the solution shall be offered in a stand beside configuration. In this scenario power is derived from either an AC power source near the accepting device or, for example a rechargeable battery within the systems enclosure. The system enclosure, wired or portable, incorporates the adapter module with the additional electronics described above. Exiting the enclosure shall be:
   a. For the wired case the module has an additional cable exiting the device which has for example, the min-USB connector as described above and an additional set of adapter connectors to support various mobile devices.
   b. For the induction case the module either incorporates the antenna directly or has an appropriate RF cable exiting the device to which the antenna is connected. For non-NFC powerpad implementations the additional mobile device adapter shall be included as described above. This shall enable a device connected to the adapter acquire power through the RF transmission.
   c. For dual operation it shall have both connector and antenna assemblies and the load sensor shall be able to detect which pathway is being used and ensure that power be supplied only through that channel. This ensures that the charging device is not overloaded.

What is claimed is:

1. System and methods for delivery of power to a mobile device, enabling the mobile device to activate and be used at a point-of-presence, enabling the holder of the device to convey the necessary information to interact at the point-of-presence. The information may either reside locally on the mobile device or utilize the mobile device as a pass-through of information secured at a remote location. The information exchanged includes either payment or rights data associated with the procurement of goods and services or use thereof previously acquired rights. A limiter shall be optionally available that shall restrict power delivery to the time period of typical activation and interaction timeframes.

2. A system of claim 1 is a solution, which is integrated within an existing point-of-presence host device and utilizes the power available from that system as the power source, which is delivered in a regulated manner to the mobile device.

3. A system of claim 1 is a solution which provides a stand-beside adjunct host device to a preexisting point-of-presence device. This stand-beside host device delivers the regulated power to the mobile device.

4. A method of claim 1 in which the power source for the mobile power delivery subsystem is acquired by tapping off of hardwired AC power distribution circuitry connected to a host device infrastructure based power distribution system.

5. A method of claim 1 in which the power source for the mobile power delivery subsystem is acquired through tapping off of an on-board power source; a battery through the host device's power distribution circuitry.

6. A method of claim 1 in which the power source for the mobile power delivery subsystem is acquired through either an external AC source, hardwired connection, or a DC on-board source;
a battery in the host device.

7. A method of claim 6 in which the power source is selected via a switch which selects the AC or DC source.

8. A method of claim 6 in which the power source is selected via a sensor which identifies if the AC wired source is available and utilizes it if present, switching to the Battery source only in instances in which the AC alternative is not available.

9. A method of claim 6 in which the power source selection is under programmatic control and based upon a program controlled setting selects which power source to utilize.

10. A method of claim 1 is a solution in which the power regulation is achieved via electronic circuitry and controlled via load sensing.

11. A method of claim 1 is a solution in which the power regulation is handled via programmatic control in which mobile device load requirements are known and circuitry gates the load delivered consistent with mobile device requirements. The information defining mobile device power characteristics is downloadable into the host device and can be updated through a configuration/update process.

12. A method of claim 11 is a solution in which the information defining mobile device power characteristics may be entered via an entry mechanism (e.g. keypad, touchscreen) into the host device as part of a configuration/update process as an alternate or complementary technique to data download.

13. A method of claim 11 shall enable the mobile device user to select the appropriate setting for their device via a User Interface on the host power delivery device.

14. A system of claim 1 that provides circuitry enabling a timing mechanism, which is activated when the load for delivering power to a mobile device is sensed or activated and shall terminate power delivery after a pre-established time interval has expired if the device remains connected or in the RF/EMR field.

15. A method of claim 14 is a physical device, such as a multi-toggle switch in the host device, which shall be preset to define a specific time interval to be used to establish a power delivery time period.

16. A method of claim 14 is a software data set that defines the time allocation for power delivery. The information defining timing restrictions is downloadable into the host device and shall be updated through a configuration/update process.

17. A method of claim 16 is a solution in which the information defining timing restrictions shall be entered via an entry mechanism (e.g. keypad, touchscreen) into the host device as part of a configuration/update process as an alternate or complementary technique to software download.

18. Systems and methods of claim 1 that provides power from a source within a host device, integrated or stand-beside, to an electronic subsystems which is capable of transferring that energy in the appropriate format to the mobile device creating a sufficient power draw to activate the mobile device and engage in operational processes to complete transaction processing.

19. A method of claim 18 in which the power delivery is channeled through RF radiation and acquired through EMR induction at the receiving mobile device. This is delivered via a broadcast antenna assembly associated with the host device. This assembly shall either be integrated into the host device or as a peripheral component connected via cable. The power source shall be converted and adjusted as required to drive the RF generation to create the necessary energy field to power the target mobile device.

20. A method of claim 19 in which the system includes a separate Mobile RF adapter inclusive of antenna, power conversion and load regulator assemblies and power made available through a standard connector such as a mini-USB male connector. This shall be provided in the event that the mobile device does not have an integrated receiving antenna and supporting power conversion circuitry.

21. A method of claim 18 in which the power is delivered from the host device to the mobile device via a cable connection which utilizes as a primary physical and logical interface an interface standard such as mini-usb and makes available at a minimum the power and ground leads as connections for the mobile device. The power source shall be converted as required to an appropriate DC level based upon mobile device requirements.

22. A method of claim 21 in which alternate physical adapters are configured to support the common mobile device power connector formats present in the marketplace. These include but are not limited to adaptors which have, based upon current state of the art, a standard mini-usb mating connector on one side and the internal circuitry to convert the wiring to the requirements of the alternate protocol. At a minimum the power and ground lines are passed through. In the example described in the specification the Apple iPhone connection standards are provided as said representations.

23. A method of claim 22 in which the set of adaptors are tethered as a single fabricated assembly to the same power cable that incorporates the primary mini-usb connector.

24. A method of claim 22 in which the alternate physical adapters are create as separate assemblies with a tethering mechanism such that they can be attached to the primary physical cable or the housing of the power distribution unit. A tie-wrap is one such attachment methodology.

25. A method of claim 22 in which the adapters are independent modules. The individual adapters are provided to the consumer at point of interaction. They physically connect the mini-usb plug via the mating connector on the adapter and then plug into the mobile device utilizing the appropriate mobile device interface.

26. A method of claim 22 in which the described alternate physical adapters are provided to connect the Mobile RF Adapter to mobile devices utilizing connectors other than the standard connector enabling the Mobile RF adapter to be used to receive and deliver the energy required to activate and operate the mobile device.

27. A method of claim 1 that provides combined wired and RF transmitted delivery of the energy required to power and activate a mobile device within a host device solution.

28. A method of claim 27 that utilizes electronics to sense whether a devices has been connected or has entered the RF field to determine through which operational mode the power shall be delivered.

29. A method of claim 27 enables an individual to select which delivery mechanism shall be utilized. A physical switch or a programmable user interface providing display and selection alternatives are such selection mechanisms by which an individual shall determine which RF or hardwired transmission method to use in delivering power to their mobile device.
